(19) United States
(12) Patent Application Publication
(10) Pub. No.: US 2007/0218224 A1
(43) Pub. Date: Sep. 20, 2007

(54) DESICCANT CARRIER FOR INSULATED GLAZING UNIT

(76) Inventor: Andrew Farbstein, Plymouth Meeting, PA (US)

Correspondence Address: SYNNESTVEDT & LECHNER, LLP, 1101 MARKET STREET, 26TH FLOOR, PHILADELPHIA, PA, 19107-2950, US

(21) Appl. No.: 11/686,655

(22) Filed: Mar. 15, 2007

Related U.S. Application Data
(60) Provisional application No. 60/782,541, filed on Mar. 16, 2006.

(51) Int. Cl. E06B 3/00

(52) U.S. Cl. 428/34; 428/35.7

(57) ABSTRACT

A carrier for holding a desiccant positionable between panes of an insulated glazing unit useable in a window assembly is disclosed. The carrier may be a vented container holding desiccant material or a gas permeable housing impregnated with desiccant. The carrier may form part of the insulated glazing unit structure by providing a connector joining elongated members that define the gas space between the panes. The carrier may also be a structural part of muntins positioned within the gas space between the panes.

### CROSS REFERENCE TO RELATED APPLICATIONS

This application is based on and claims priority to U.S. Provisional Application No. 60/782,541, filed Mar. 16, 2006.

### FIELD OF THE INVENTION

This invention relates to devices for absorbing moisture from the gas contained between the panes of an insulated glazing unit used in insulated window assemblies.

### BACKGROUND OF THE INVENTION

Significant energy savings may be realized through the use of insulated glazing units in structures such as homes, offices, apartment complexes and the like. The insulated glazing units comprise at least two panes mounted on a spacer frame positioned between the panes. The spacer frame defines a gas space between the panes which inhibits heat transfer between the inside and outside of the unit. The unit may be mounted in a fixed frame structure or a sash to form a window assembly.

The gas space is normally sealed and inaccessible. Therefore, any moisture which is trapped in the gas space will remain there and tend to condense and become visible on one of the panes when the temperature of the ambient air in contact with that pane drops below the dew point of the gas within the gas space. As the gas space is substantially inaccessible, it is not possible to conveniently clear the pane of the condensate. It would be advantageous to remove the moisture from the gas within the gas space so as to avoid cycles of condensation on the inside surfaces of the panes comprising an insulated glazing unit.

### SUMMARY OF THE INVENTION

The invention concerns a carrier for holding a desiccant. The carrier is positionable between window panes in a window assembly for absorbing moisture from a gas contained in a space between the panes. In one embodiment, the carrier comprises a container having sidewalls defining a volume for holding the desiccant. At least one of the sidewalls has at least one aperture therethrough. The aperture is positionable facing the space between the panes and allows the gas to circulate within the container from between the window panes. The desiccant in the container absorbs moisture from the gas.

In another embodiment, the carrier comprises a housing, at least a portion of which is gas permeable and impregnated with the desiccant. In a particular embodiment, the housing comprises a structural component formed of a desiccant composition. The component assists in coupling together elongated members which form an insulated glazing unit. In this embodiment, the desiccant composition assists in providing mechanical strength to the housing.

The housing may comprise a polymer selected from the group consisting of polypropylene, polyethylene, polystyrene, ABS, polycarbonate, nylon, PVC, thermoplastic elastomers, polyesters and thermoset plastics. The housing further comprises a channeling agent which provides the permeability. The channeling agent is selected from the group consisting of polyglycol, polyethylene glycol, EVOH and glycerin. The desiccant is selected from the group consisting of molecular sieves, silica gel, zeolites, cations and combinations thereof.

Alternately, the housing may comprise an activated silico-aluminate combined with polymer binders.

For any of the housing embodiments described above, the housing may have an elongated, substantially straight form and act as a connector between elongated elements of the spacer frame. The housing could alternatively have end portions angularly oriented with respect to one another and act as a connector at a corner of the spacer frame.

The invention also encompasses an insulated glazing unit. The unit comprises a pair of panes in spaced apart relation. A spacer frame defines a space between the panes for holding a gas. The spacer frame comprises a plurality of elongated members connected to one another end to end. Each of the elongated members has a first surface engageable with one of the window panes and a second surface, positioned in spaced relation opposite to the first surface. The second surface is engageable with another of the window panes. A carrier holding a desiccant is positioned between the first and the second panes. The desiccant absorbs moisture from the gas between the panes. The carrier may comprise any of the embodiments described above. The insulated glazing unit may also include a muntin positioned between the panes. The muntin comprises a plurality of prismatic members connected to one another. The carrier may be mounted on at least one of the prismatic members for absorbing moisture from the gas in the gas space.

The invention further encompasses a window assembly. The window assembly according to the invention comprises a frame in which the aforementioned insulated glazing unit is mounted. The frame may be fixed, or may comprise a sash movable within an outer frame.

### BRIEF DESCRIPTION OF THE DRAWINGS

FIGS. 1 and 1A are front views of double pane window assembly embodiments having insulated glazing units according to the invention;

FIG. 2 is a partial sectional view of the window assembly shown in FIGS. 1 and 1A and taken at circle 2;

FIG. 2A is a partial sectional view of an alternate embodiment of the window assembly shown in FIGS. 1 and 1A and taken at circle 2;

FIG. 3 is a partial sectional view of the window assembly shown in FIGS. 1 and 1A and taken at circle 3;

FIG. 3A is a partial sectional view of an alternate embodiment of the window assembly shown in FIGS. 1 and 1A and taken at circle 3;

FIGS. 4 and 4A are partial sectional views of the window assembly shown in FIGS. 1 and 1A and taken at circle 4;

FIG. 5 is a partial sectional view of an alternate embodiment the window assembly shown in FIGS. 1 and 1A and taken at circle 4;

FIGS. 6 and 6A are partial sectional views of the window assembly shown in FIGS. 1 and 1A and taken at circle 6;

FIG. 7 and 7A are partial sectional views of an alternate embodiment the window assembly shown in FIGS. 1 and 1A and taken at circle 7;

FIG. 8 is a partial sectional view of the window assembly shown in FIGS. 1 and 1A and taken at circle 8;

FIG. 9 is a partial sectional view of an alternate embodiment the window assembly shown in FIGS. 1 and 1A and taken at circle 9;

FIG. 10 is a partial sectional view of the window assembly shown in FIGS. 1 and 1A and taken at circle 10;

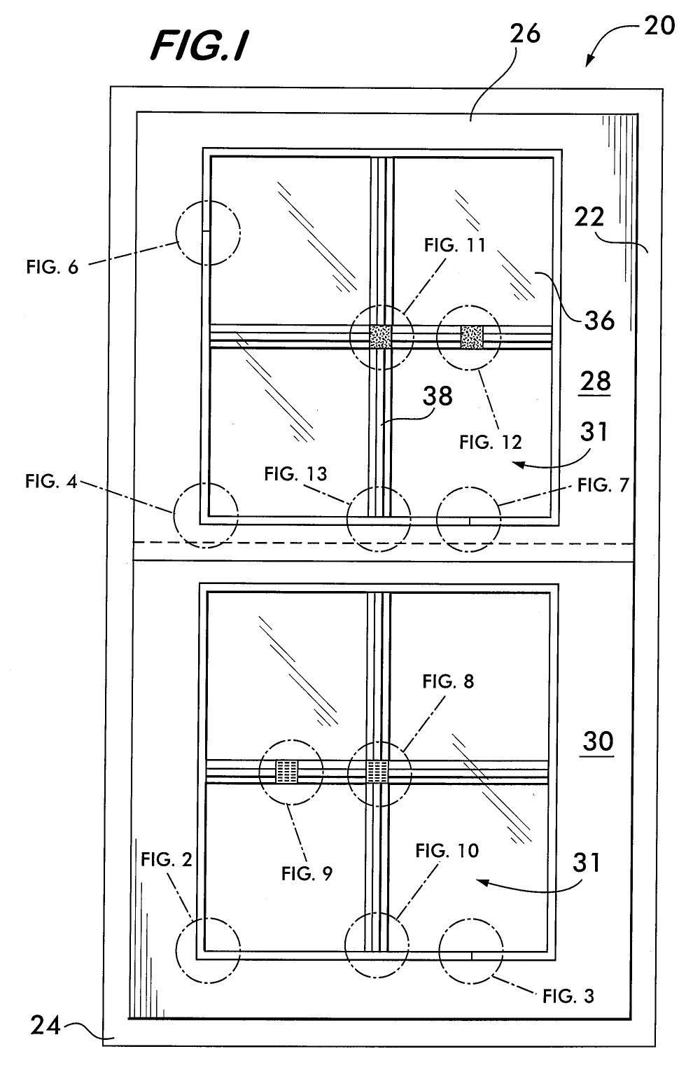

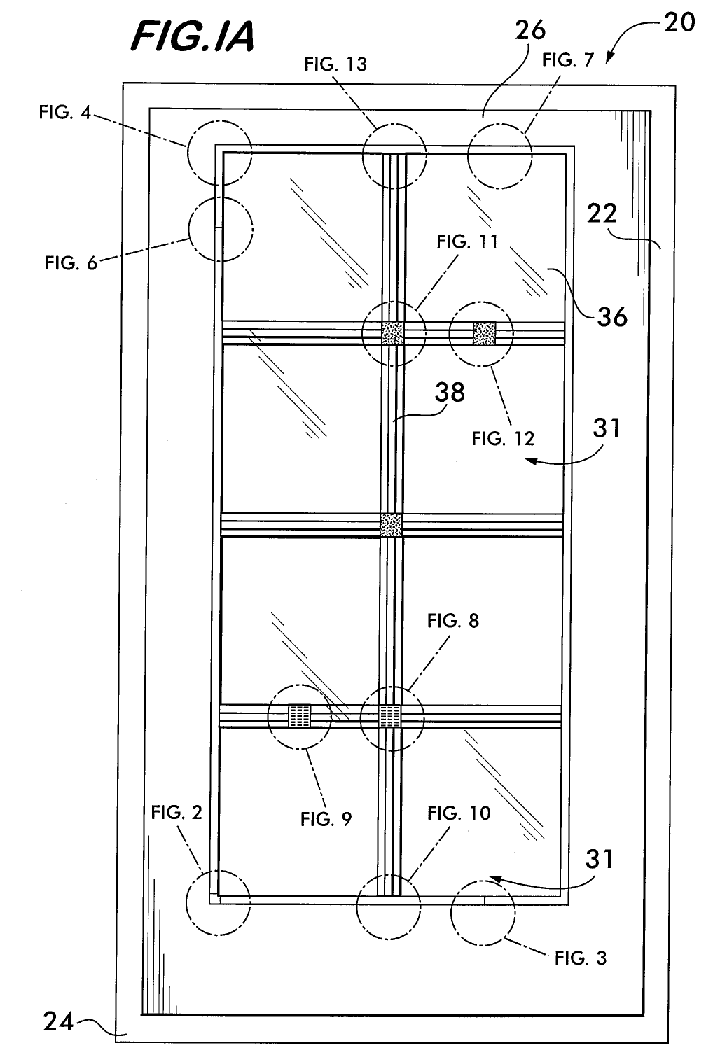

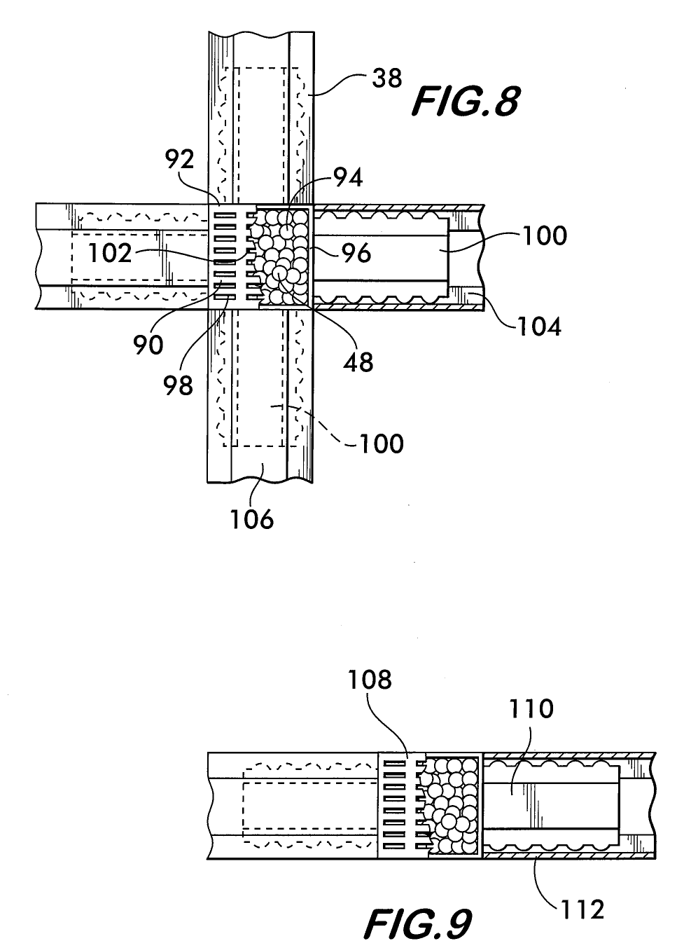

FIG. 9 is a partial sectional view of the window assembly shown in FIG. 1 and taken at circle 9;

FIG. 11 is a partial sectional view of the window assembly shown in FIGS. 1 and 1A and taken at circle 11;

FIG. 12 is a partial sectional view of the window assembly shown in FIGS. 1 and 1A and taken at circle 12; and

FIG. 13 is a partial sectional view of the window assembly shown in FIGS. 1 and 1A and taken at circle 13.

### DETAILED DESCRIPTION OF THE EMBODIMENTS

FIG. 1 shows a window assembly 20 according to the invention. The window assembly comprises a frame 22 including a sill 24 and a head 26. Sashes 28 and 30 are mounted in the frame. The frame and sashes may be made of wood, metal, vinyl or other durable materials. An insulated glazing unit 31 is mounted within each sash. Alternately, as shown in FIG. 1A, an insulated glazing unit 31 may be mounted directly in a frame 22. The following description pertains to either embodiment.

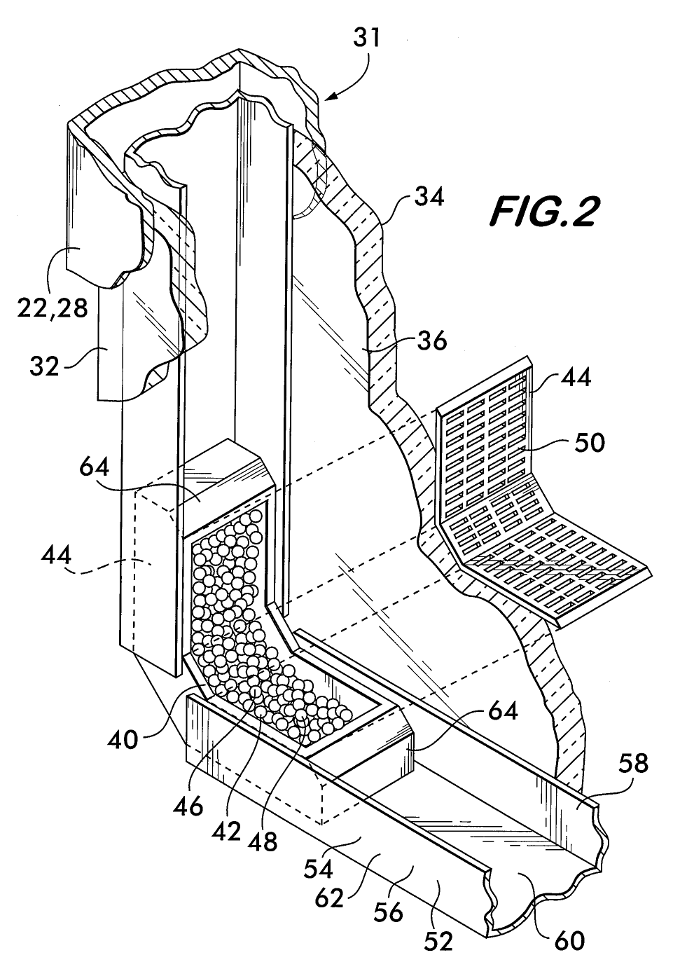

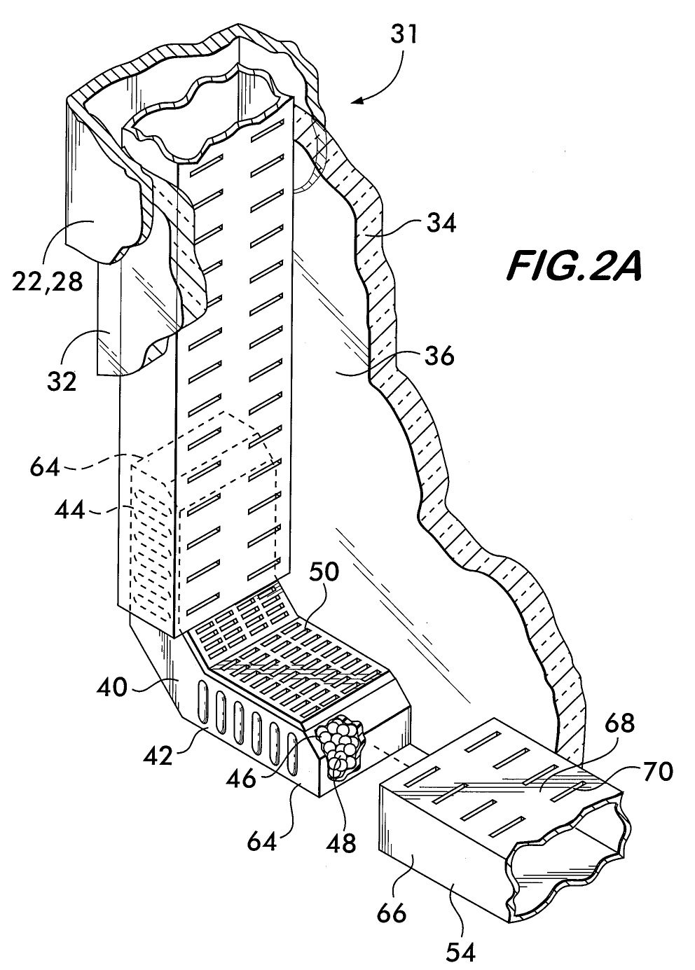

As shown in FIG. 2, the insulated glazing unit 31 comprises two panes 32 and 34 in spaced apart relation with a gas space 36 between them to provide insulation. The panes may be formed of glass, a polymer or other light transmitting material as appropriate. The panes are mounted on a spacer frame 54 (described in detail below) which separates the panes and defines the gas space. The gas captured in the gas space may be air, argon or another substantially inert gas which provides insulation. In addition to providing insulation, the gas space 36 also provides room for positioning muntins 38 (see FIGS. 1 and 1A) between the panes within the gas space. The muntins so positioned provide the appearance that the window assembly is divided into a plurality of individual panes.

It is advantageous to ensure that the gas within the gas space 36 remains dry so that water condensate does not form on the inside surfaces of the panes when the temperature of the ambient air in contact with one of the panes drops, cooling the gas within the gas space. To this end, a desiccant composition is positioned between the panes to absorb moisture from the gas in the gas space.

The desiccant composition is composed of a desiccant. Suitable desiccants which can be used in the composition include, but are not limited to, desiccants that obtain their moisture absorbing capabilities through physical absorption. The absorption process is accomplished because of a fine capillary morphology of the desiccant particles which pulls moisture therethrough. The pore size of the capillaries, as well as the capillaries' density determine the absorption properties of the desiccant. Suitable desiccants include, but are not limited to, silica gel, molecular sieve, calcium carbonate and naturally occurring clay compounds, which would also include montmorillonite clay.

In another embodiment, the desiccant composition includes one or more of the following: “loose” desiccants, and desiccant plastic compositions comprising formulations that are used to mold shaped articles comprising 2-phase and 3-phase compositions. A 2-phase composition is one that consists of a desiccant and a base polymer. A 3-phase composition is one that consists of a desiccant and at least 2-immiscible base polymers. In one embodiment of the present invention, the loading of the desiccant can range from about 10% to about 80%, more particularly about 30% to about 70% (weight).

In another embodiment, the base polymer is selected from a group of thermoplastics that include polyolefins-polyethylene (LDPE, LLDPE, HDPE) and polypropylene may be used. Suitable 3-phase desiccant entrained plastic compositions include, but are not limited to, these desiccant plastics disclosed in one or more of the following U.S. Pat. Nos. 5,911,937; 6,214,255; 6,130,263; 6,080,350; 6,174,952; 6,124,006; and 6,221,446. These patents are incorporated herein by reference.

For purposes of the present invention, the following terms are used in one or more of the above identified patents to mean:

1. Channeling Agent—a material that is melted and forms passages throughout the polymer base.

2. Channels/Passages—solid pathways that extend throughout the polymer base from the exterior surface of the plastic structure into its interior.

3. Hydrophilic—having a greater moisture transmission rate than the polymer base material.

By varying the desiccant loading and channeling agent in the plastic formulation, the overall moisture capacity and uptake rate of the desiccant entrained plastic can be controlled. Desiccant compositions, as described above, are available from CSP Technologies of Auburn, Ala.

In yet another embodiment, the polymer may comprise thermoset plastics.

Other examples of desiccant compositions include a desiccant combined with a binder. For example, crystalline silico-aluminate combined with polymer binders which give the finished desiccant laden material properties similar to thermoset plastics. Materials of this type are available from Multisorb Technologies of Buffalo, N.Y.

FIG. 2 illustrates one embodiment of a desiccant carrier 40. Carrier 40 comprises a container 42 having sidewalls 44 surrounding and defining a volume 46 for holding a desiccant 48. At least one of the sidewalls 44 has apertures 50 that are positioned facing the gas space 36 to allow moisture laden gas to enter the volume 46 and permit the moisture to be captured by the desiccant 48. The container 42 is preferably formed of resilient plastic and is positioned within an elongated member, in this embodiment a channel 52 that forms the spacer frame 54. The channel has flanges 56 and 58 connected by a web 60. The flanges provide surfaces 62 engageable with the panes 32 and 34 to keep them in spaced apart relation and define the gas space 36. A sealant (not shown for clarity) between the panes and the surfaces hermetically seals the gas space. In this example embodiment, the container 42 acts as a connector to connect the channels 52 in end-to-end relation to form the spacer frame 54. The end portions 64 of the container 42 are angularly oriented with respect to one another, in this example, at a right angle so as to join the channels at a corner.

In an alternate embodiment, shown in FIG. 2A, the elongated members forming the spacer frame 54 are hollow tubes 66 that receive the end portions 64 of the container 42. Tubes 66 have a surface 68 which faces the gas space 36. Openings 70 are located in the surface 68 to permit gas to circulate into the container 42 to interact with the desiccant therein.

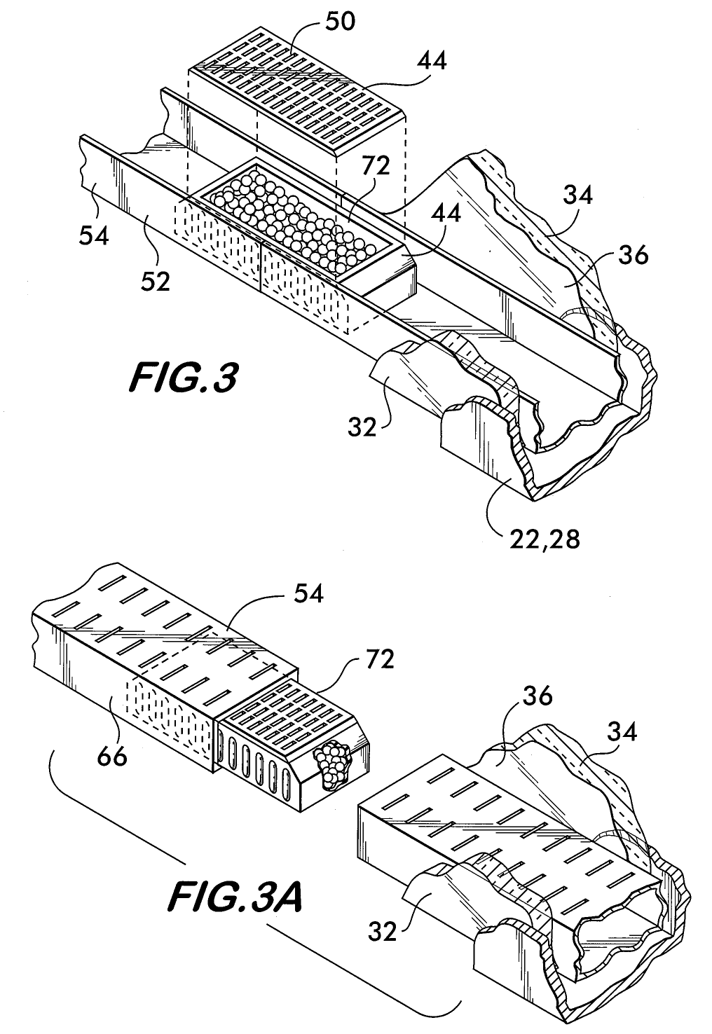

FIG. 3 shows another container embodiment 72 positioned within a channel 52 forming part of a spacer frame 54 in the window assembly 20. Container 72 has an elongated, substantially straight form, but is otherwise identical to the aforementioned container, with sidewalls 44 having apertures 50 facing the gas space 36 to permit gas to pass into and out of the container and interact with the desiccant 48 therein. FIG. 3A shows container 72 positioned within a hollow tube 66 which forms the spacer frame 54.

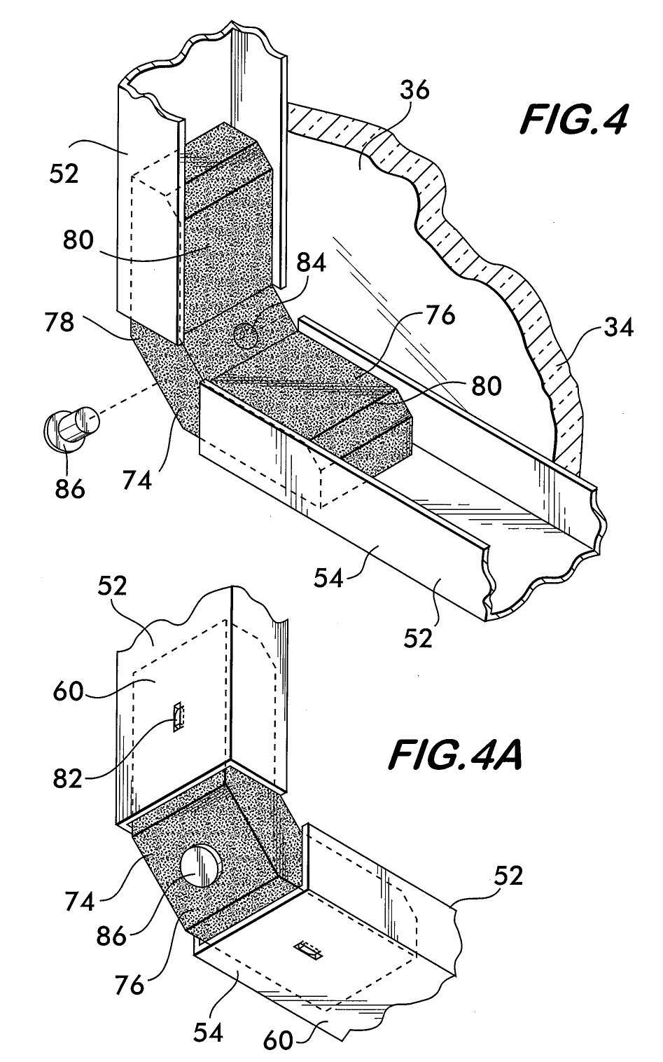

FIGS. 4 and 4A illustrate a desiccant carrier 74 formed of a gas permeable housing 76 impregnated with a desiccant 78. Preferably, housing 76 comprises a structural component formed of a desiccant composition as described above. The structural component assists in coupling the elongated members forming the spacer frame together. The desiccant composition also assists in providing mechanical strength to the housing. In this example embodiment, the housing 76 has end portions 80 oriented at a right angle to one another to form a connector between elongated members (channels 52) comprising the spacer frame 54. To facilitate positioning and engagement between the housing 76 and the channels, a projection 82 extends outwardly from housing 76 and is received within a hole in the channel web 60. The housing may also have a gas port 84 which allows the gas space 36 to be purged with an inert gas, for example, argon to enhance the insulating characteristics of the window assembly. The gas port is sealed with a plug 86.

Gas permeable housing 76 may be formed from a polymer such as polypropylene, polyethylene, polystyrene, ABS, polycarbonate, nylon, PVC, thermoplastic elastomers, polyesters or thermoset plastics. The polymer is mixed with a channeling agent, such as polyglycol, polyethylene glycol, EVOH or glycerin. The desiccant, for example, molecular sieves, silica gel, zeolites, cations and combinations thereof, is also combined with the polymer/channeling agent mixture, and the mixture is further processed to create a three-phase system which contains a network of interconnecting channels leading from the surface of the housing to the desiccant particles captured within the material. Other examples of desiccant impregnated material include crystalline silico-aluminate combined with polymer binders which give the finished desiccant laden material properties similar to thermoset plastics.

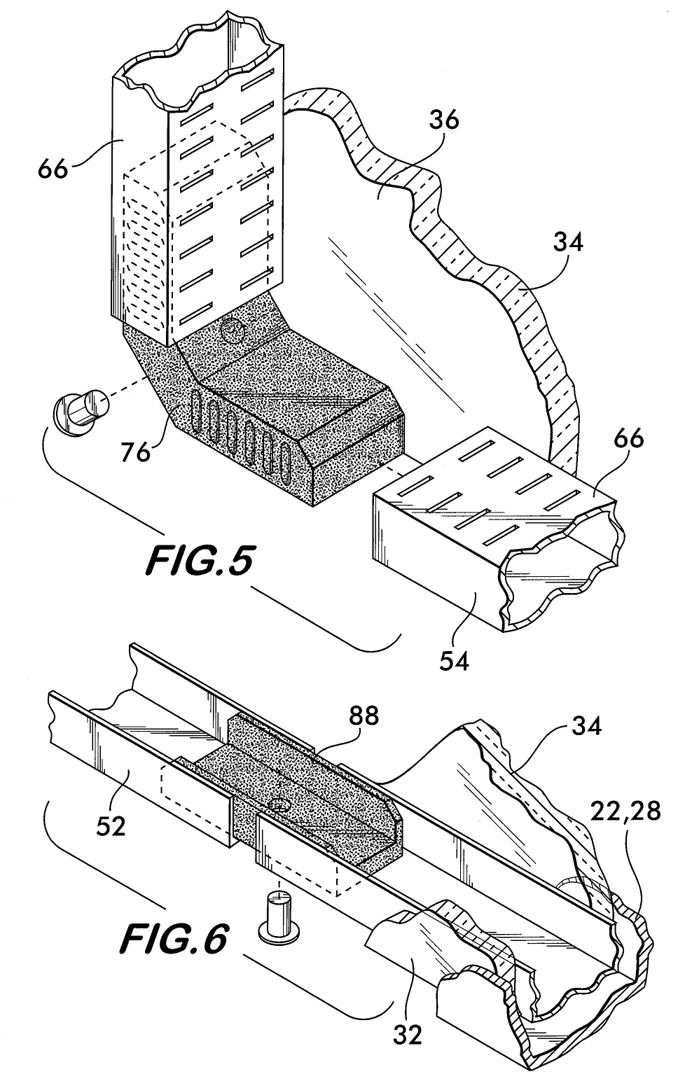

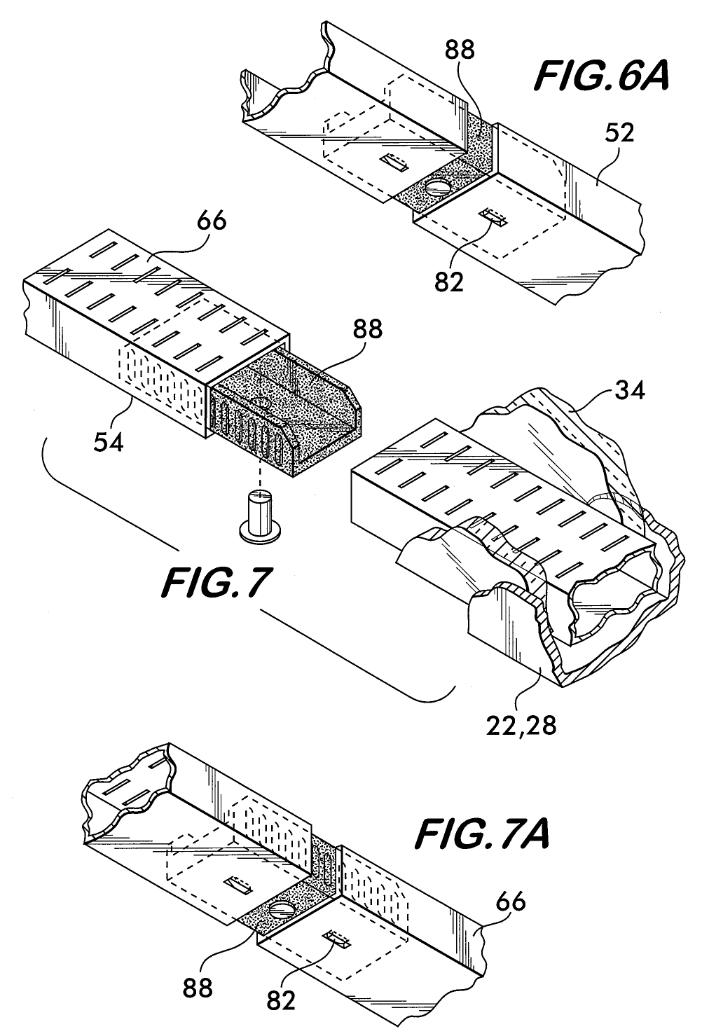

FIG. 5 shows a gas permeable desiccant impregnated housing 76 used as a corner connector for a spacer frame 54 formed of hollow tubes 66. FIG. 6 shows a housing 88 having an elongated, substantially straight form and used as a connector between two straight sections of channel 52. As shown in FIG. 6A, the housing 88 again has projections 82 to facilitate positioning and engagement with the channel elements. FIGS. 7 and 7a show the housing 88 used as a connector between hollow tubes 66 to form a spacer frame 54 in the window assembly 20.

As shown in FIGS. 1 and 1A, the gas space 36 between panes 32 and 34 allows muntins 38 to be positioned between the panes and provide the appearance of multiple panes in the window assembly 20. Muntins 38 may also provide the structure for mounting desiccant carriers within the gas space according to the invention. FIG. 8 shows a carrier 90 comprising a container 92 holding desiccant 48 within a volume 94 defined by sidewalls 96. The sidewalls 96 are vented with apertures 98 to permit gas flow to the desiccant, and the container has a cruciform shape. Four engagement portions 100 extend outwardly from a central intersection 102 of the container 92. Engagement portions 100 are insertable coaxially within bores 104 of elongated members 106 forming the muntin 38.

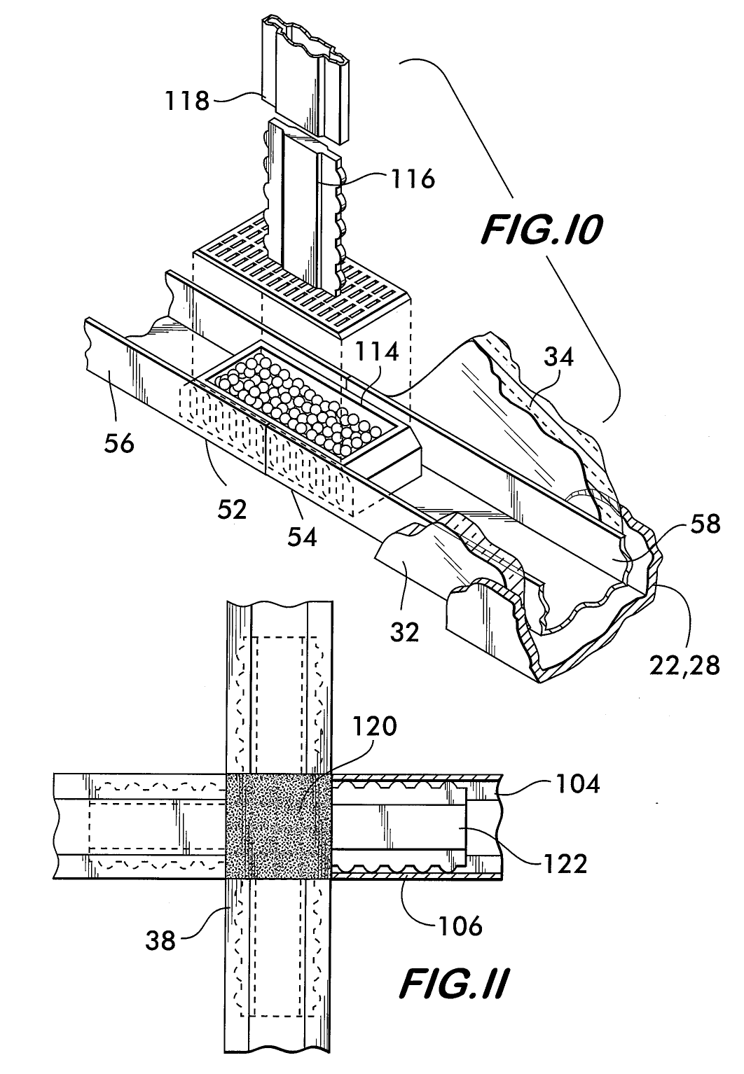

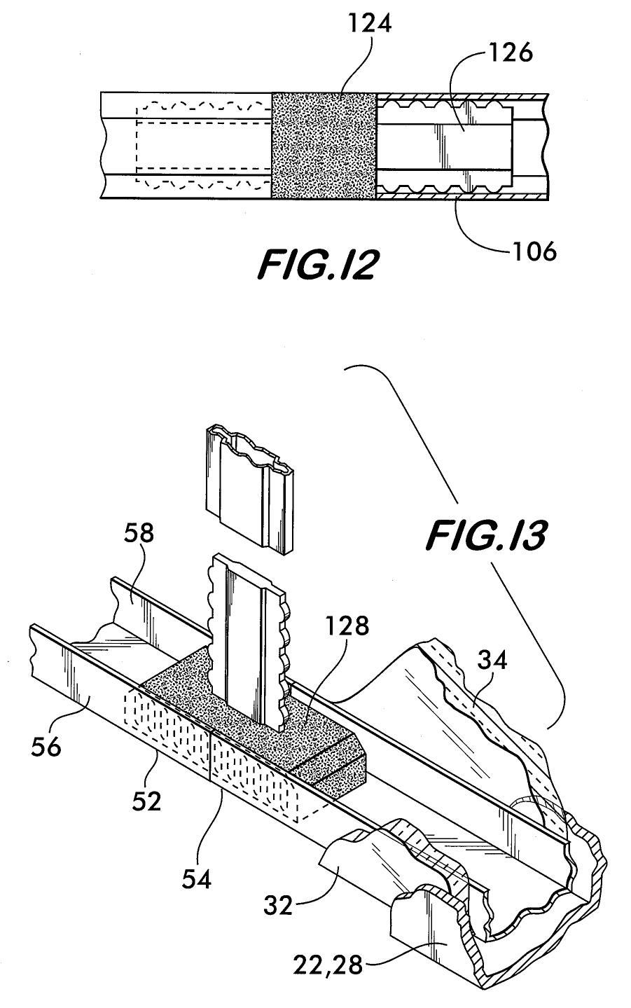

In another embodiment, shown in FIG. 9, a container 108 has an elongated, substantially straight form with extending engagement portions 110 at each end. The engagement portions fit coaxially within elongated muntin members 112. FIG. 10 shows a container 114 with an engagement portion 116 engaging a muntin member 118, the container 114 being hidden between the flanges 56, 58 of a channel 52 forming a spacer frame 54 of the window assembly.

Muntins 38 can also support a gas permeable desiccant impregnated housing 120 as shown in FIG. 11. The housing again comprises a structural component, this time of the muntin. The structural component assists in coupling prismatic members of the muntin together, and the desiccant composition assists in providing mechanical strength to the housing.

Housing 120 is formed of the desiccant compositions described above, for example, the polymer/channeling agent/desiccant material or the silico-aluminate/binder and has a cruciform shape. Oppositely disposed end portions 122 are insertable coaxially within bores 104 of prismatic muntin members 106 to provide a connector. FIG. 12 shows a gas permeable desiccant impregnated housing 124 having an elongated, substantially straight form with oppositely disposed end portions 126 engageable with muntin members 106, again forming a connector. As shown in FIG. 13, a gas permeable desiccant impregnated housing 128 is mounted at the end of a muntin member 106 and positioned between flanges 56 and 58 of a channel 52 forming a spacer frame 54 of the window assembly 20.

Desiccant carriers according to the invention provide a convenient device for absorbing moisture from the gases in the gas space within a double pane window assembly which can be readily integrated into the window assembly structure.

What is claimed is:

1. A carrier for holding a desiccant, said carrier being positionable between panes in an insulated glazing unit for absorbing moisture from a gas in a space between said panes, said carrier comprising a housing, at least a portion of which is gas permeable and impregnated with said desiccant, said desiccant absorbing moisture from said gas between said panes.

2. A carrier according to claim 1, wherein said housing comprises a structural component formed of a desiccant composition, said structural component assisting in coupling elongated members of said insulated glazing unit together.

3. A carrier according to claim 1, wherein said housing comprises a polymer selected from the group consisting of polypropylene, polyethylene, polystyrene, ABS, polycarbonate, nylon, PVC, thermoplastic elastomers, polyesters and thermoset plastics.

4. A carrier according to claim 3, wherein said housing further comprises a channeling agent selected from the group consisting of polyglycol, polyethylene glycol, EVOH and glycerin.

5. A carrier according to claim 4, wherein said desiccant is selected from the group consisting of molecular sieves, silica gel, zeolites, cations and combinations thereof.

6. A carrier according to claim 1, wherein said housing comprises an activated silico-aluminate combined with polymer binders.

7. A carrier according to claim 1, wherein said housing has an elongated substantially straight form.

8. A carrier according to claim 1, wherein said housing has first and second end portions oriented angularly with respect to one another.

9. A carrier according to claim 8, wherein said first and second end portions are positioned at substantially right angles to one another.

10. A carrier according to claim 1, wherein said housing has a cruciform shape.

11. An insulated glazing unit comprising:
a pair of panes in spaced apart relation;
a spacer frame positioned between said panes and defining a space therebetween for holding a gas, said spacer frame comprising:
a plurality of elongated members connected to one another end to end, each said elongated member having a first surface sealingly engaged with one of said panes and a second surface, positioned in spaced relation opposite to said first surface, said second surface being sealingly engaged with another of said panes; and
a housing, at least a portion of which is gas permeable and impregnated with said desiccant, said housing being positioned between said panes, said desiccant absorbing moisture from said gas between said panes.

12. An insulated glazing unit according to claim 11, wherein said housing comprises a structural component formed of a desiccant composition, said structural component assisting in coupling said elongated members to one another.

13. An insulated glazing unit according to claim 11, wherein said housing comprises a polymer selected from the group consisting of polypropylene, polyethylene, polystyrene, ABS, polycarbonate, nylon, PVC, thermoplastic elastomers, polyesters and thermoset plastics.

14. An insulated glazing unit according to claim 13, wherein said housing further comprises a channeling agent selected from the group consisting of polyglycol, polyethylene glycol, EVOH and glycerin.

15. An insulated glazing unit according to claim 14, wherein said desiccant is selected from the group consisting of molecular sieves, silica gel, zeolites, cations and combinations thereof.

16. An insulated glazing unit according to claim 11, wherein said housing comprises an activated silico-aluminate combined with polymer binders.

17. An insulated glazing unit according to claim 11, wherein said housing has an elongated substantially straight form with opposite ends adapted to engage two of said elongated members and act as a connector therebetween.

18. An insulated glazing unit according to claim 11, wherein said housing has first and second end portions oriented angularly with respect to one another.

19. An insulated glazing unit according to claim 18, wherein said first and second end portions are positioned at substantially right angles to one another, said end portions being adapted to engage said elongated members and act as a connector therebetween at a corner of said spacer frame.

20. An insulated glazing unit according to claim 11, further comprising a muntin positioned between said panes, said muntin comprising a plurality of prismatic members connected to one another, said housing being mounted on at least one of said prismatic members.

21. An insulated glazing unit according to claim 20, wherein said housing has an elongated substantially straight form, a portion of said housing being inserted coaxially within a bore of said at least one prismatic member.

22. An insulated glazing unit according to claim 20, wherein said housing has oppositely disposed end portions inserted coaxially within bores of two of said prismatic members, said housing acting as a connector joining said prismatic members.

23. An insulated glazing unit according to claim 20, wherein said housing has a cruciform shape comprising four portions extending outwardly from a central intersection, said four portions being inserted coaxially within bores of four of said prismatic members to act as a connector joining said prismatic members.

24. A window assembly, comprising:
a frame;
an insulated glazing unit mounted within said frame, said insulated glazing unit comprising:
a pair of panes in spaced apart relation;
a spacer frame positioned between said panes and defining a space therebetween for holding a gas, said spacer frame comprising:
a plurality of elongated members connected to one another end to end, each said elongated member having a first surface sealingly engaged with one of said panes and a second surface, positioned in spaced relation opposite to said first surface, said second surface being sealingly engaged with another of said panes; and
a housing, at least a portion of which is permeable and impregnated with said desiccant, said housing being positioned between said panes, said desiccant absorbing moisture from said gas between said panes.

25. A window assembly according to claim 24, wherein said housing comprises a structural component formed of a desiccant composition, said structural component assisting in coupling said elongated members together.

26. A window assembly according to claim 24, wherein said housing comprises a polymer selected from the group consisting of polypropylene, polyethylene, polystyrene, ABS, polycarbonate, nylon, PVC, thermoplastic elastomers, polyesters and thermoset plastics.

27. A window assembly according to claim 26, wherein said housing further comprises a channeling agent selected from the group consisting of polyglycol, polyethylene glycol, EVOH and glycerin.

28. A window assembly according to claim 27, wherein said desiccant is selected from the group consisting of molecular sieves, silica gel, zeolites, cations and combinations thereof.

29. A window assembly according to claim 24, wherein said housing comprises an activated silico-aluminate combined with polymer binders.

30. A window assembly according to claim 24, wherein said housing has an elongated substantially straight form with opposite ends adapted to engage two of said elongated members and act as a connector therebetween.

31. A window assembly according to claim 24, wherein said housing has first and second end portions oriented angularly with respect to one another.

32. A window assembly according to claim 31, wherein said first and second end portions are positioned at substantially right angles to one another, said end portions being adapted to engage said elongated members and act as a connector therebetween at a corner of said spacer frame.

33. A window assembly according to claim 24, further comprising a muntin positioned between said panes, said muntin comprising a plurality of prismatic members connected to one another, said housing being mounted on at least one of said prismatic members.

34. A window assembly according to claim 33, wherein said housing has an elongated substantially straight form, a portion of said housing being inserted coaxially within a bore of said at least one prismatic member.

35. A window assembly according to claim 33, wherein said housing has oppositely disposed end portions inserted coaxially within bores of two of said prismatic members, said housing acting as a connector joining said prismatic members.

36. A window assembly according to claim 33, wherein said housing has a cruciform shape comprising four portions extending outwardly from a central intersection, said four portions being inserted coaxially within bores of four of said prismatic members to act as a connector joining said prismatic members.

37. A window assembly according to claim 24, further comprising a sash mounted within said frame, said insulated glazing unit being mounted within said sash.
